(19) United States
(12) Patent Application Publication
(10) Pub. No.: US 2006/0168758 A1
(43) Pub. Date: Aug. 3, 2006

(54) Hinge structure

(76) Inventors: Teng-Chao Chiang, Hsinchu City (TW); Sheng-Hsung Yang, Hsinchu County (TW)

Correspondence Address: RABIN & BERDO, P.C.;Suite 500, 1101 14 Street, N.W., Washington, DC, 20005, US

(21) Appl. No.: 11/043,957

(22) Filed: Jan. 28, 2005

(51) Int. Cl. E05D 11/08

(52) U.S. Cl. 16/342

(57) ABSTRACT

A hinge structure is disclosed. Each of a pair of axles is inserted into a first pivot hole of the body through a second pivot hole of the cover, to enable the cover to be swiveled about the axle relative to the body. When the body and the cover are coupled together, a second anchor ring of the axle is deformed through a deformation slot of the axle and is inserted into the second pivot hole and the first pivot hole and latched on one end of the first pivot hole. A first anchor ring of the axle is latched in the second pivot hole on another end of the first pivot hole. A movable brake member of the axle and the wall of the first pivot hole generate a frictional force to enable the cover to be swiveled relative to the body and anchored at any angle desired.

### FIELD OF THE INVENTION

The present invention relates to a hinge structure and particularly to a hinge structure for use on a directional antenna to enable a directional plate to swivel relative to a base dock.

### BACKGROUND OF THE INVENTION

With the rapid advance of electronic technology, desktop computers or notebook computers now have powerful functions and are widely used by companies, enterprises and consumers. In order to effectively link those computers to transmit or exchange information and data, most companies or enterprises have installed signal cables and servers to set up required internal networks. As design and actual wiring of the fixed line network is expensive, and construction and wiring of the fixed line network often result in damage of the building, it is a severe problem, especially for the company, which rents or leases offices. Moreover, the entangled wiring also is difficult to manage and maintain. Hence these days many companies or enterprises use wireless networks to set up required internal networks.

Refer to FIG. 1 for a conventional directional antenna 10 now used. The directional antenna 10 includes a base dock 11 and a directional plate 12, which is pivotally coupled on the base dock 11. The directional plate 12 may be swiveled freely to allow users to adjust the direction and tilting angle as desired so that it may be directed towards a wireless server to enhance the effectiveness of receiving radio signals.

The base dock 11 has a signal transmission line 13 on a rear side to transmit the received radio signals from the directional plate 12 to a communication module such as a network card, a network chip set or the like of a computer host 14. Then the signals are decoded by the communication module to generate digital data or messages to be used by the operating system of the computer host 14.

In general, the directional plate 12 contains an antenna array, which is laid densely. Users can adjust the direction of the directional plate 12 to accurately align with the wireless server to enhance the gain of signal concentration and improve radio signal transmission and receiving.

However, in the present directional antenna 10, the base dock 11 and the directional plate 12 usually are coupled through a universal joint. Hence the directional plate 12 can be swiveled relative to the base dock 11 only in a plane formed by X-Y axes, but cannot be adjusted in the Z axis. This limitation hampers radio signal transmission.

Moreover, the directional antenna 10 generally is positioned on a horizontal platform (such as a desktop, computer host, or the like) for transmitting and receiving radio signals. If users want mount the directional antenna 10 onto a wall or a metal partition in the office to save space or because of other requirements, the antenna cannot function. This is another limitation.

### SUMMARY OF THE INVENTION

As the conventional antenna adopted the universal joint limits the antenna to swivel relative to the base dock only on a plane formed by X-Y axes, and may be positioned only on a horizontal platform and cannot be hung on a wall or mounted onto a metal partition, installation is inflexible. Therefore the primary object of the present invention is to provide a hinge structure for a directional antenna to enable a directional plate to be pivotally coupled on one side of a base dock, to swivel relative to the base dock as desired.

The hinge structure according to the invention includes a body, a cover and a pair of axles.

The body is the base dock in the conventional directional antenna. The body has a pair of first coupling section extended upwards from one side. The two coupling sections have respectively a first pivot hole corresponding to each other. The first pivot hole has an anchor end.

The cover is the directional plate of the conventional directional antenna. It has a housing space to hold a circuit board, a reflective plate and other electronic elements. The cover has a second coupling section extended from one side. The second coupling section is located between the two first coupling sections. The second coupling section has second pivot holes respectively corresponding to two sides of the first pivot hole, and an anchor hole connecting to the second pivot hole.

The axle is inserted into the first pivot hole through the second pivot hole so that the cover may be turned relative to the body about the axis of the axle. The axle has a first anchor ring, an anchor member connecting to the first anchor ring, a movable brake member, a second anchor ring and one or more deformation slot.

When the body and the cover are coupled, the second anchor ring is deformed due to the deformation slot and is inserted into the second pivot hole and the first pivot hole, and latched on the anchor end of the first pivot hole. The anchor member is inserted into the anchor hole to be in contact with the first coupling section. The first anchor ring is coupled with the second pivot hole. The brake member and the wall of the first pivot generate a frictional force to enable the cover to be turned relative to the body and anchored at any angle desired. Hence the directional plate may be adjusted and moved to a desired position in the Z axis, to accurately align with the location of the wireless server, to enhance the gain of signal concentration, and facilitate radio signal transmission and receiving.

The body has a hanging hole on the bottom so that the entire directional antenna may be hung on a wall. Moreover, the body has a magnetic element to enable the entire hinge structure to be attracted to a metal material, such as a metal partition. Such a design can enhance the installation flexibility of the hinge structure.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional directional antenna;

FIGS. 2A and 2B are a perspective view and an exploded view of the hinge structure of the invention;

FIGS. 3A and 3B are a perspective view and an exploded view of the body of the hinge structure;

FIGS. 4A and 4B are a perspective view and an exploded view of the cover of the hinge structure;

FIGS. 4C and 4D are a bottom view of an upper cap and a perspective view of a lower cap;

FIG. 5 is a perspective view of the axle; and

FIG. 6 is a bottom perspective view of the hinge structure with the axle coupled with the first coupling section and the second coupling section.

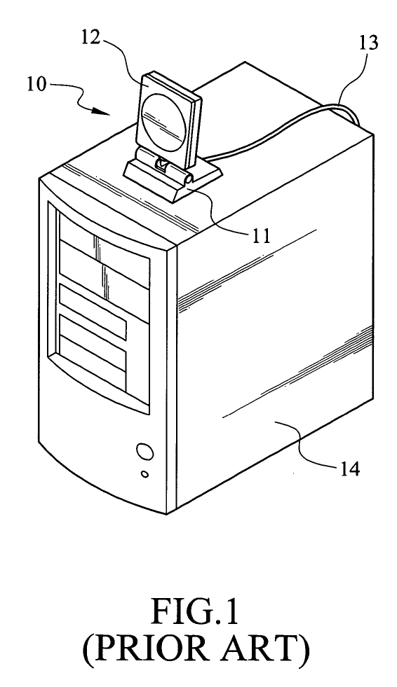

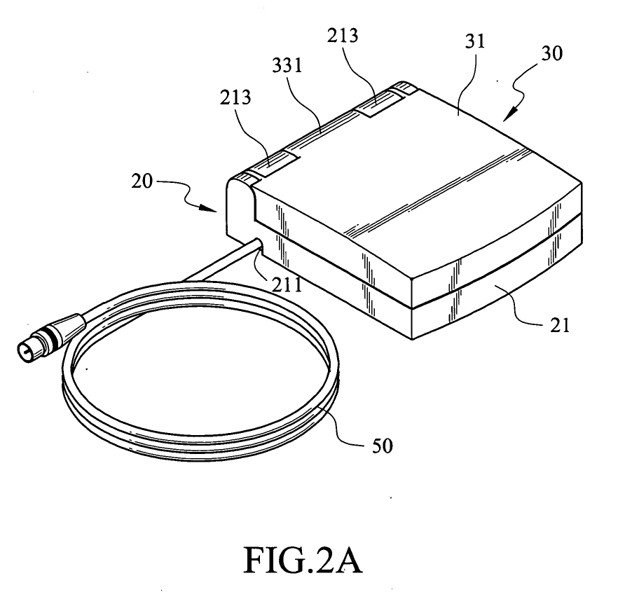

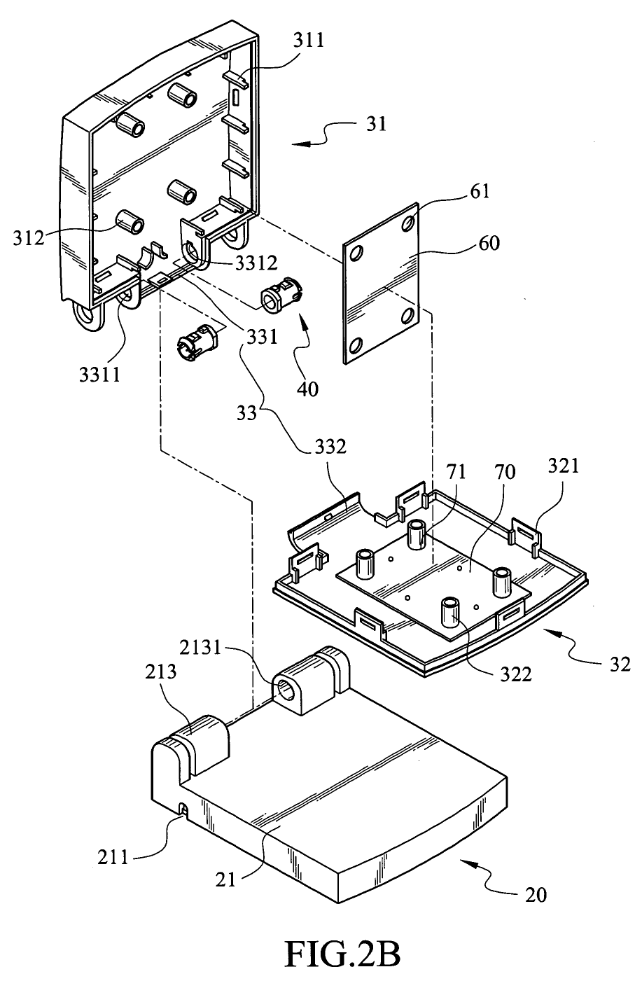

### DESCRIPTION OF THE PREFERRED EMBODIMENTS

The hinge structure according to the invention mainly is adopted for use on a directional antenna to pivotally couple a directional plate on one side of a base dock, and enable the directional plate to be swiveled relative to the base dock. However, the hinge structure of the invention also can be used on other mechanisms or electronic devices that have a cover to be opened and closed relative to a body, such as a flipping mobile phone, palm size computer, P DA, and the like. The following discussion is based on an embodiment of the directional antenna.

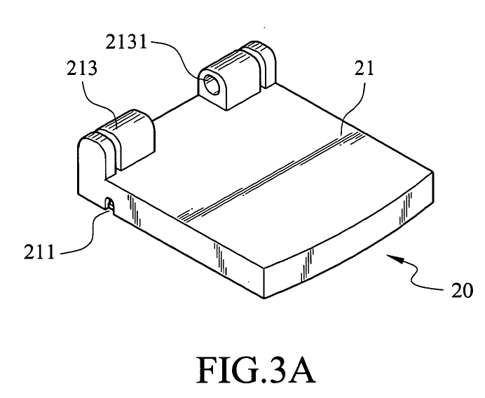

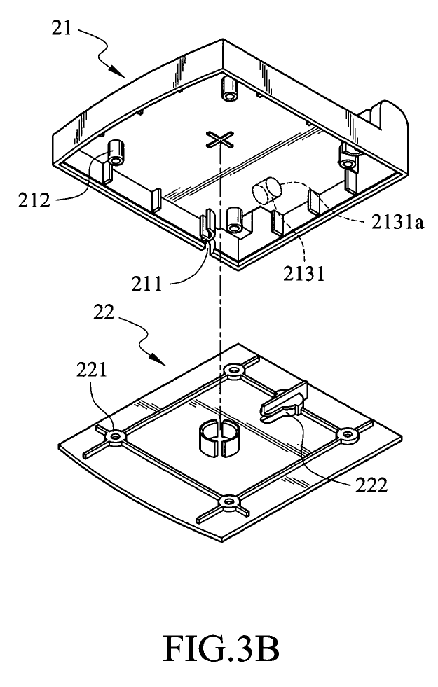

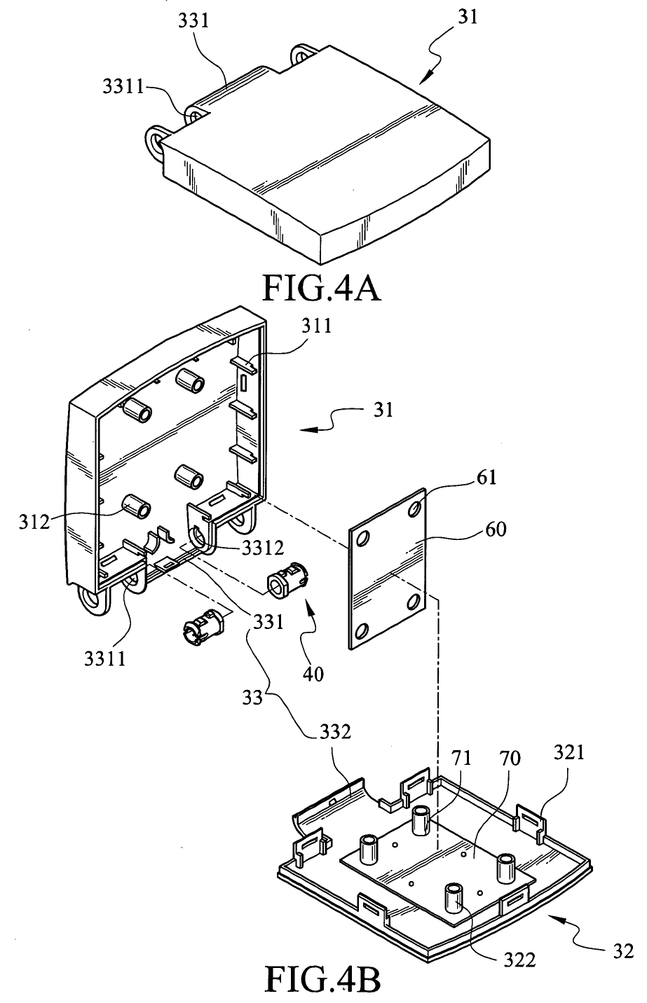

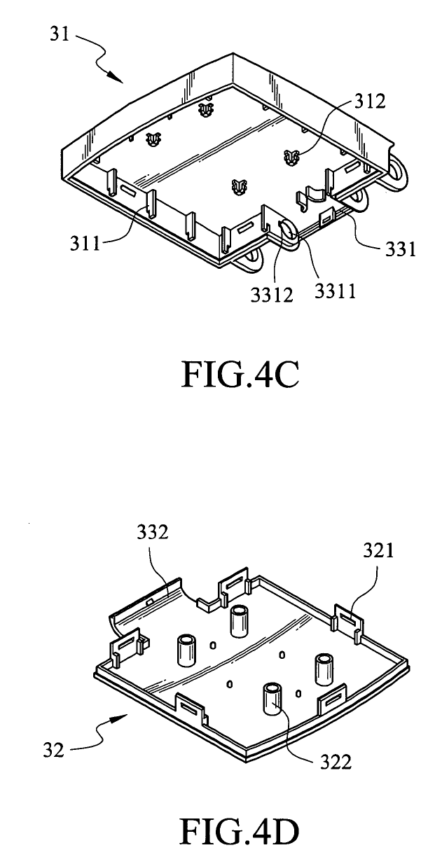

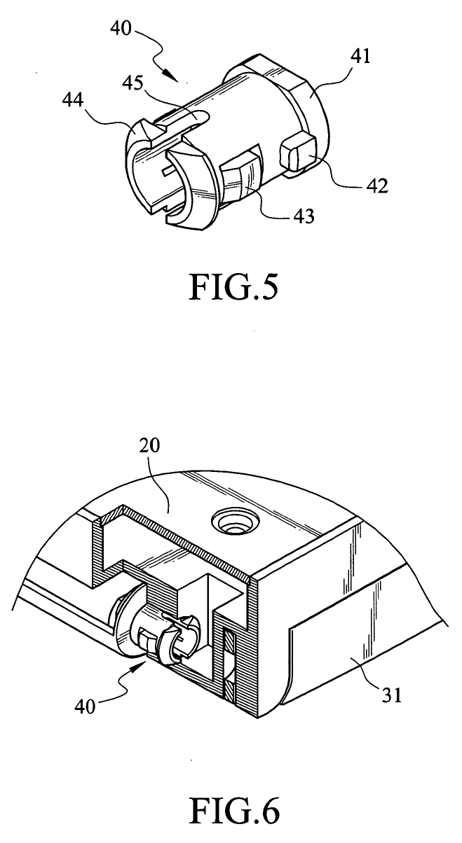

Refer to 2A and 2B for a perspective view and an exploded view of the hinge structure of the invention, FIGS. 3A and 3B for a perspective view and an exploded view of the body of the hinge structure, FIGS. 4A and 4B for a perspective view and an exploded view of the cover of the hinge structure, FIGS. 4C and 4D for a bottom view of an upper cap and a perspective view of a lower cap, FIG. 5 for a perspective view of the axle, and FIG. 6 for a bottom perspective view of the hinge structure with the axle coupled with the first coupling section and the second coupling section.

The hinge structure according to the invention includes three main portions: a body 20, a cover 30 and an axle 40. The structure and assembly relationships among the elements are elaborated as follows:

The body 20 is the base dock of the conventional directional antenna. It is a box structure consisting of a base dock 21 and a bottom board 22 to house electronic elements required in the directional antenna or a signal transmission line 50 and the like. The signal transmission line 50 passes through an aperture 211 formed on one side of the base dock 21 and is connected to a computer host or other electronic data processing equipment. The base dock 21 has a plurality of first fastening section 212. The bottom board 22 has a plurality of second fastening sections 221 corresponding to the first fastening sections 212. The first fastening section 212 is a sleeve. The second fastening section 221 is an aperture with an internal screw thread. By screwing a screw element into the second fastening section 221 and the first fastening section 212, the base dock 21 and the bottom board 22 may be coupled together. Of course, there are other coupling methods besides the one set forth above. For instance, the base dock 21 and the bottom board 22 may also be coupled through latch couplers or other means.

The bottom board 22 has a hanging hole 222 for hanging the entire directional antenna on a wall.

The base dock 21 has a pair of first coupling sections 213 extended upwards from one side. The two first coupling sections 213 are spaced from each other at a selected distance. Each of the first coupling sections 213 has a first pivot hole 2131 that corresponds to another. Each pivot hole 2131 has an anchor end 2131 a to anchor the axle 40.

The cover 30 is the directional plate of the conventional antenna. It includes an upper cap 31 and a lower cap 32 that are coupled to form a housing space to hold a circuit board 60, a reflective plate 70 and the like.

The upper cap 31 and the lower cap 32 have respectively a first coupling plate 331 and a second coupling plate 332 extended from one side that correspond to each other. The first coupling plate 331 and the second coupling plate 332 are coupled to form a second coupling section 33. The second coupling section 33 is located between the two first coupling sections 213. The first coupling plate 331 has a second pivot hole 3311 corresponding to each of two sides of the first pivot hole 2131 and an anchor hole 3312 connecting to the second pivot hole 3311.

The upper cap 31 has a plurality of third fastening sections 311 on the periphery. The lower cap 32 has a plurality of fourth fastening sections 321 on the periphery, corresponding to the third fastening sections 311. By coupling the third fastening sections 311 with the fourth fastening sections 321, the upper cap 31 may be coupled with the lower cap 32. In this embodiment, the third fastening section 311 is a latch member, and the fourth fastening section 321 is a notch. By coupling the latch member with the notch, the upper cap 31 and the lower cap 32 may be coupled together. Of course, the third fastening section 311 and the fourth fastening section 321 may also be coupled through other means.

In addition, the upper cap 31 has a plurality of first anchor members 312, and the lower cap 32 has a plurality of second anchor members 322, corresponding to the first anchor members 312. The first anchor members 312 and the second anchor members 322 aim to anchor the circuit board 60 on the cover 30. The circuit board 60 has a plurality of apertures 61 corresponding to the first anchor members 312 and the second anchor members 322. Hence when the circuit board 60 is placed in the housing space of the cover 30, the first anchor members 312 and the second anchor members 322 can run through the apertures 61 to anchor the circuit board 60. In this embodiment, the first anchor member 312 is a strut, while the second anchor member 322 is a sleeve to receive the strut to couple together. Of course, the first anchor member 312 and the second anchor member 322 may be formed in other manners to achieve the coupling purpose. Similarly, the reflective plate 70 has a plurality of apertures 71 corresponding to the first and second anchor members 312 and 322.

The two axles 40 are inserted into the first pivot hole 2131 of the first coupling section 213 through the second pivot hole 3311 of the second coupling section 33, and are anchored on the anchor end 2131a so that the cover 30 may be swiveled relative to the body 20 about the axle 40.

The axle 40 is a hollow duct made from elastic plastics or metal. It mainly includes a first anchor ring 41, an anchor member 42 connecting to the first anchor ring 41, a movable brake member 43, a second anchor ring 44 and one or more deformation slots 45.

The first anchor ring 41 is extended outside the wall of the duct to latch in the second pivot hole 3311. The anchor member 42 is inserted into the anchor hole 3312 on one side of the second pivot hole 3311 to be in contact with the first coupling section 213. The deformation slot 45 aims to deform and shrink the second anchor ring 44 to pass through the first pivot hole 2131, and through the second anchor ring 44 to latch on the anchor end 2131a of the first pivot hole 2131 to hold the axle 40 securely.

When the body 20 is coupled with the cover 30 though the axle 40, the second anchor ring 44 is deformed through the deformation slot 45 to pass through the second pivot hole 3311 of the second coupling section 33 and the first pivot hole 2131 of the first coupling section 213 and to be latched on the anchor end 2131a. The anchor member 42 runs through the anchor hole 3312 to be in contact with the wall of the first coupling section 213 so that the first anchor ring 41 is latched in the second pivot hole 3311 to anchor the entire axle 40. The movable brake member 43 and the wall of the first pivot hole 2131 generate a frictional force to allow the cover 30 to be swiveled relative to the body 20 and to be anchored at any angle desired. Thus users can turn the cover 30 to accurately align with the wireless server.

Moreover, the body 20 has a magnetic element 23 so that the hinge structure may be attached to a metal material by attraction, such as a metal partition. The body 20 has one or more retaining members 24 to hold the magnetic element 23.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments, which do not depart from the spirit and scope of the invention.

What is claimed is:

1. A hinge structure, comprising:
a body, which has a pair of first coupling sections extended from one side, each of the first coupling sections having a first pivot hole corresponding to each other, each first pivot hole having an anchor end;
a cover, which has a housing space in the interior, and a second coupling section extended from one side and located between the first coupling sections, the second coupling section having second pivot holes respectively corresponding to two sides of the first pivot hole and an anchor hole connecting to the second pivot hole; and
a pair of axles, which are inserted into the first pivot holes through the second pivot holes to allow the cover to be swiveled about the axle relative to the body, each of the axles including a first anchor ring, an anchor member coupled to the first anchor ring, a movable brake member, a second anchor ring and at least one deformation slot;
wherein when the body and the cover are coupled, the second anchor ring is deformed through the deformation slot and is inserted into the second pivot hole and the first pivot hole to latch on the anchor end, the anchor member being inserted into the anchor hole to be in contact with the first coupling section, the first anchor ring being latched in the second pivot hole, the brake member and a wall of the first pivot hole generating a friction force to allow the cover to be swiveled relative to the body and anchored at any angle desired.

2. The hinge structure of claim 1, wherein the body further has a base dock and a bottom board, the first coupling section being formed on the base dock.

3. The hinge structure of claim 2, wherein the base dock has at least one first fastening section, and the bottom board has at least one second fastening section corresponding to the first fastening section, the first fastening section being coupled with the second fastening section to couple the base dock with the bottom board.

4. The hinge structure of claim 2, wherein the bottom board further has a hanging hole.

5. The hinge structure of claim 1, wherein the cover further has an upper cap and a lower cap, the upper cap and the lower cap having respectively a first coupling plate and a second coupling plate extended from one side thereof to couple together to form the second coupling section.

6. The hinge structure of claim 5, wherein the upper cap has at least one third fastening section on the periphery, and the lower cap has at least one fourth fastening section corresponding to the third fastening section, the third fastening section and the fourth fastening section being coupled together to couple the upper cap with the lower cap.

7. The hinge structure of claim 5, wherein the upper cap has at least one first anchor member, and the lower cap has at least one second anchor member corresponding to the first anchor member.

8. The hinge structure of claim 7, wherein the housing space of the cover holds a circuit board which has at least one aperture corresponding to the first anchor member, the first anchor member and the second anchor member running through the aperture for holding and anchoring the circuit board in the housing space.

9. The hinge structure of claim 1, wherein the body has a magnetic element to attach the hinge structure on a metal material by attraction.

10. The hinge structure of claim 9, wherein the body has at least one retaining member to hold the magnetic element.

11. The hinge structure of claim 1, wherein the axles are made from an elastic material.
